(19) United States
(12) Patent Application Publication
(10) Pub. No.: US 2015/0263415 A1
(43) Pub. Date: Sep. 17, 2015

(54) ANTENNA PROVIDED WITH APPARATUS FOR EXTENDING BEAM WIDTH FOR MOBILE COMMUNICATION BASE STATION

(71) Applicant: KMW Inc., Hwaseong (KR)

(72) Inventors: Young-Chan Moon, Hwaseong (KR); Sung-Hwan So, Hwaseong (KR); Hun-Jung Jung, Hwaseong (KR); Jae-Jeng Choi, Hwaseong (KR)

(73) Assignee: KMW Inc.

(21) Appl. No.: 14/727,061

(22) Filed: Jun. 1, 2015

Related U.S. Application Data
(63) Continuation of application No. PCT/KR2013/010998, filed on Nov. 29, 2013.

(30) Foreign Application Priority Data
Nov. 30, 2012 (KR) 10-2012-0137901

(51) Int. Cl. H01Q 1/24; H01Q 19/10

(52) U.S. Cl. CPC H01Q 1/246; H01Q 19/104

(57) ABSTRACT

Disclosed is an antenna provided with an apparatus for extending beam width for a mobile communication base station. An antenna for a base station according to an embodiment of the present invention comprises: a reflector plate; an emitting element disposed on the reflector plate; and an apparatus for extending the width of a beam, the apparatus being fixedly disposed at a previously set distance from the emitting element in the direction of emission thereof and made of thin metal.

### CROSS REFERENCE TO RELATED APPLICATIONS

This application is a continuation of International Application No. PCT/KR2013/010998 filed on Nov. 29, 2013, which claims priority to Korean Applications No. 10-2012-0137901 filed on Nov. 30, 2012, which applications are incorporated herein by reference.

### TECHNICAL FIELD

The present invention relates to a base station antenna used in a mobile communication system and, more particularly, relates to a base station antenna having a beam-width expanding apparatus for expanding the beam width of a radiating element included in an antenna.

### BACKGROUND ART

Antennas used in base stations as well as repeaters in mobile communication systems may have various shapes and structures, and in recent years, base station antennas have generally used a dual-band dual-polarized antenna structure by applying a polarization diversity method.

The dual-band dual-polarized antenna generally has a structure in which first radiating elements in a low frequency band (e.g., a band of 700 MHz) and second radiating elements in a high frequency band (e.g., a band of 1.9 GHz) are properly arranged on at least one reflection plate that stands erect in the longitudinal direction. The first and second radiating elements are used to transmit (or receive) two orthogonal linear polarizations that are arranged at +45° and −45° to the vertical (or the horizontal).

An example of such a dual-band dual polarized antenna is disclosed in KR Patent Application No. 2000-7010785 first filed by Kathrein-Verke AG (entitled ‘Dual polarized multi-range antenna’).

Meanwhile, the horizontal beam width of radiation beams generated by each radiating element (and a combination of radiating elements) of a base station antenna is one of the very important characteristics of the corresponding antenna. Constant studies on the design of a radiating element and an antenna have been conducted to satisfy a beam width required for service conditions and environments. The studies have been conducted in a direction of increasing the beam width where possible in order to allow the corresponding antenna to have a wider coverage range.

### SUMMARY

An aspect of the present invention is to provide a mobile communication base station antenna including a beam-width expanding apparatus that can expand the beam width of a radiating element with a comparatively simple structure and the minimum addition of equipment without affecting the radiation characteristic of the antenna where possible.

In accordance with one aspect of the present invention, a mobile communication base station antenna including a beam-width expanding apparatus is provided. The mobile communication base station antenna includes: a reflection plate; a radiating element mounted on the reflection plate; and a beam-width expanding apparatus that is fixedly mounted to be separated a preset distance upward from the radiating element and constituted by a thin metal body.

### BRIEF DESCRIPTION OF THE DRAWINGS

FIG. 1 is a plan view of a beam-width expanding apparatus in a mobile communication base station antenna according to an embodiment of the present invention;

FIGS. 2A and 2B illustrate the structure of the beam-width expanding apparatus mounted to each radiating element of the mobile communication base station antenna according to the embodiment of the present invention;

FIG. 3 is a perspective view of the radiating element and the beam-width expanding apparatus which are illustrated in FIGS. 2A and 2B;

FIGS. 4A and 4B illustrate the structure of a mobile communication base station antenna including a beam-width expanding apparatus, according to an embodiment of the present invention; and

FIG. 5A and 5B schematically illustrate a state in which a beam width is expanded by a beam-width expanding apparatus mounted to each radiating element of the mobile communication base station antenna according to the embodiment of the present invention.

### DETAILED DESCRIPTION

Hereinafter, an exemplary embodiment according to the present invention will be described in detail with reference to the accompanying drawings. In the accompanying drawings and the descriptions relating thereto, identical elements are indicated by identical reference numerals where possible.

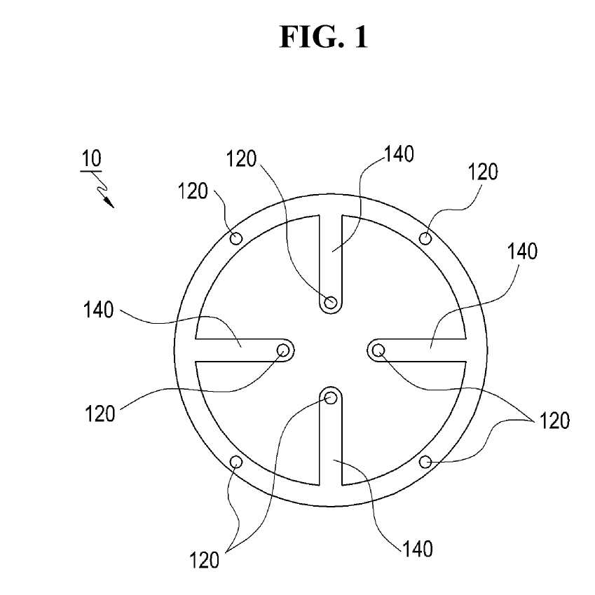

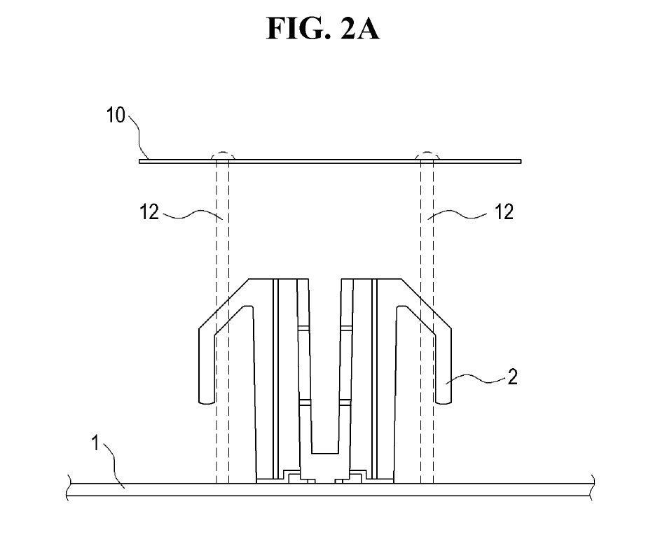

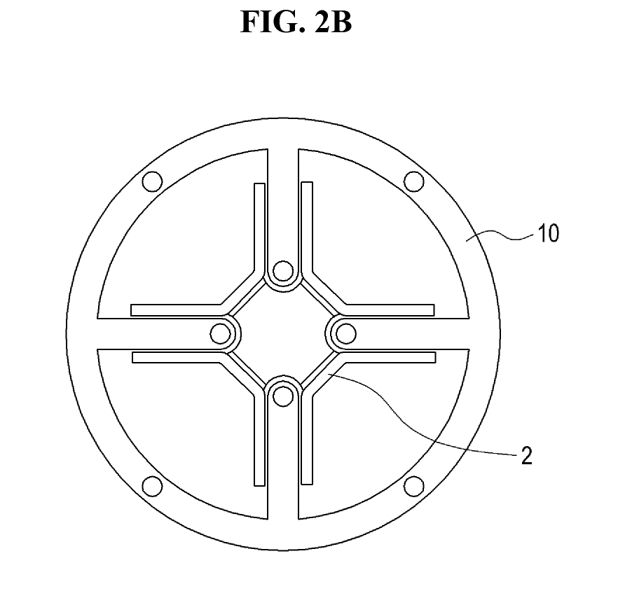

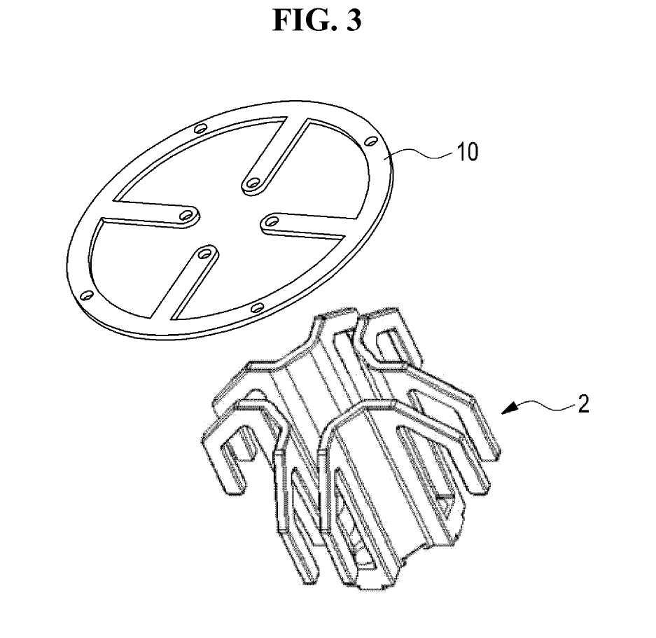

FIG. 1 is a plan view of a beam-width expanding apparatus in a mobile communication base station antenna according to an embodiment of the present invention. FIGS. 2A and 2B are a side view and a plan view of the beam-width expanding apparatus mounted to each radiating element of the mobile communication base station antenna according to the embodiment of the present invention, where FIGS. 2A and 2B illustrate a state in which the beam-width expanding apparatus illustrated in FIG. 1 is mounted to the radiating element. FIG. 3 is a perspective view of the radiating element and the beam-width expanding apparatus which are illustrated in FIGS. 2A and 2B.

Referring to FIGS. 1 to 3, the beam-width expanding apparatus 10 to be mounted to the mobile communication base station antenna, according to the embodiment of the present invention, is fixedly mounted to be spaced a proper distance apart from each radiating element 2 of the mobile communication base station antenna in the radiating direction of the radiating element.

The beam-width expanding apparatus 10 may be constituted by, for example, a circular thin metal body. The beam-width expanding apparatus 10 may be constituted by a thin metal body made of a conductive material. For example, the beam-width expanding apparatus 10 may be constituted in a structure in which a copper or aluminum thin metal body is plated with silver.

The beam-width expanding apparatus 10 is disposed above the radiating element 2 based on the center of beams radiated from the radiating element 2 (i.e., for example, disposed such that the beam-width expanding apparatus 10 shares the same central axis with the radiating element 2). The beam-width expanding apparatus 10 is disposed to be included within the beam width of beams radiated in an initial stage from the radiating element 2 to have a direct influence on the pattern of the radiated beams. In this case, the total size and the shape of the beam-width expanding apparatus 10 as well as the mounting position thereof are designed in comprehensive consideration of the pattern of the initially radiated beams from the radiating element 2, a change in the radiation pattern according to the mounting of the beam-width expanding apparatus 10, radiation loss, and the like.

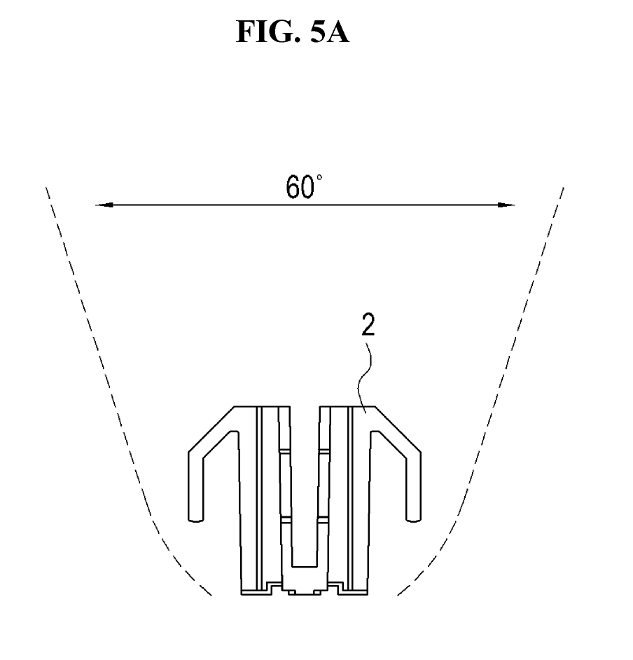

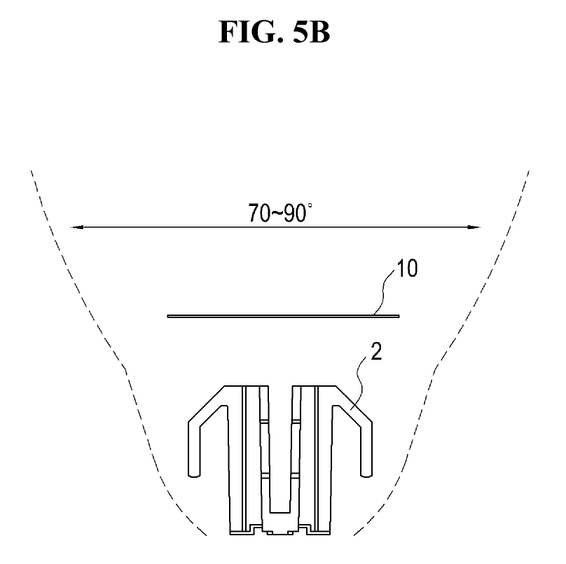

FIGS. 5A and 5B illustrate a state in which the beam-width of the beams radiated from the radiating element 2 expands when the beam-width expanding apparatus 10 is disposed above the radiating element 2. FIG. 5A schematically illustrates the beam width of beams radiated from the radiating element 2 in a general state in which the beam-width expanding apparatus 10 is not mounted, and FIG. 5B schematically illustrates the beam-width of beams radiated from the radiating element 2 in a state in which the bema-width expanding apparatus 10, according to the embodiment of the present invention, is mounted. As illustrated in FIG. 5A and 5B, in the general state, the beam width of the beams radiated from the radiating element 2 may be 60 degrees, whereas when the beam-width expanding apparatus 10 of the present invention is mounted, the beam width of the beams radiated from the corresponding radiating element 2 may be 70 to 90 degrees.

The expansion of the beam width due to the beam-width expanding apparatus 10 is based on the principle that the radiation pattern of beams changes when an object having permittivity is placed near a portion of the radiating element 2 that radiates beams.

Of course, in this case, the beam-width expanding apparatus 10 placed near the portion of the radiating element 2 that radiates beams causes a loss in terms of a radiation gain, and therefore the beam-width expanding apparatus 10 is constituted to be as thin as possible in order to reduce such a loss. In cases where the beam-width expanding apparatus 10 is constituted to be thin enough, even though a loss is caused due to this, it is possible to sufficiently satisfy a radiation characteristic required for the corresponding radiating element 2.

The beam-width expanding apparatus 10 may have a planar circular ring shape as illustrated in FIG. 1, and may additionally have one or more branch portions 140 extending inward, for example toward the center, from the circular ring shape. Likewise, the branch portions 140 are constituted by a thin metal piece. In addition, the beam-width expanding apparatus 10 may have a plurality of through holes 120 formed in the branch portions 140 and the circular ring shape, in which support parts 12 to be described below are inserted into and secured to the through holes 120.

The detailed structure of the beam-width expanding apparatus 10 including the plurality of branch portions 140 has an influence on the pattern of beams, radiated from the radiating element 2, in the same way. Since a comparatively small structural difference also causes a considerable variation in the beam pattern, particularly, the beam width, the optimum structure is obtained by experimentally identifying the corresponding radiation characteristic when a detailed structure is added or modified.

In cases where the beam-width expanding apparatus 10 having such a configuration is disposed above the radiating element 2, the beam-width expanding apparatus 10 is secured to a reflection plate 1 through the separate support parts 12 as clearly illustrated in FIG. 2A. The support parts 12 may be formed of synthetic resin, such as plastic, not to affect the radiation characteristic of the radiating element 2 where possible, and may include a screw (made of plastic) coupled via the through holes 120 formed in the beam-width expanding apparatus 10 to fix the beam-width expanding apparatus 10. Furthermore, in this case, the support parts 12 may be secured to the reflection plate 1 in a screw-coupling manner through thread holes (not illustrated) formed in advance in the reflection plate 1. At this time, it can be seen that the support parts 12 are configured and mounted such that one side of each support part is coupled to the reflection plate 1 and the other side thereof is coupled to the beam-width expanding apparatus 10.

Of course, even in this case, the pattern of beams radiated from the radiating element 2 is affected by the support parts 12 that support the beam-width expanding apparatus 10. Therefore, additionally considering this, the detailed structure and the mounting position of the support parts 12 and the beam-width expanding apparatus 10 are designed.

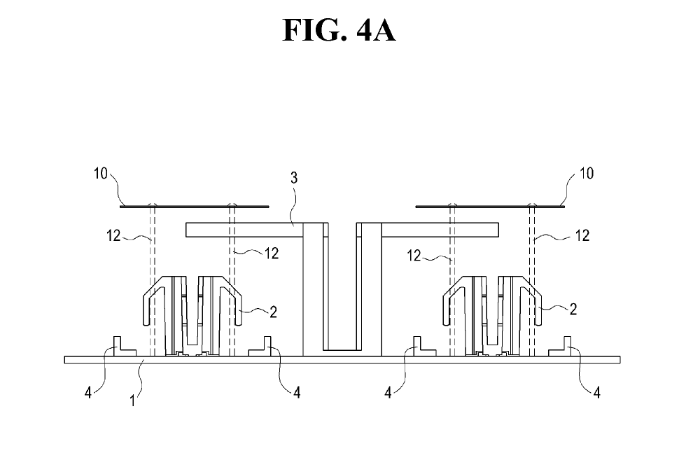

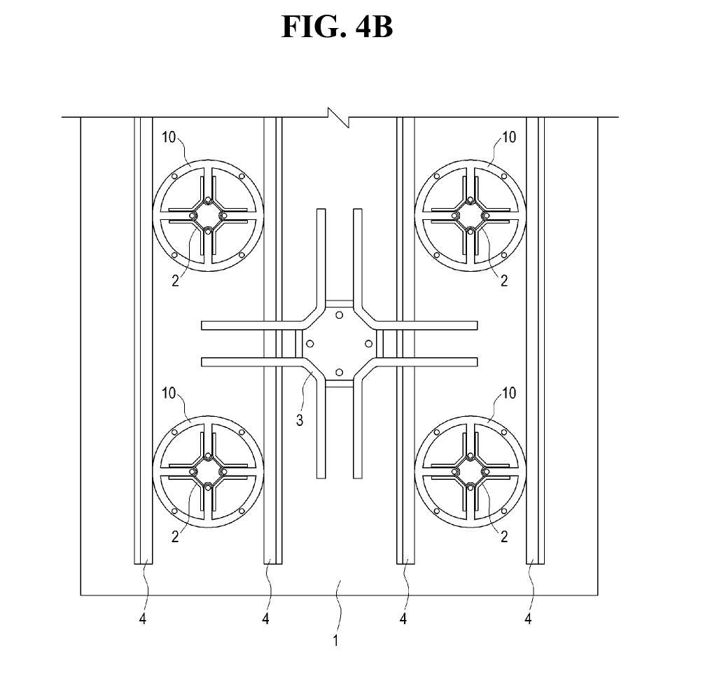

FIGS. 4A and 4B illustrate the structure of a mobile communication base station antenna including a beam-width expanding apparatus, according to an embodiment of the present invention, where FIG. 4A illustrates a side structure, and FIG. 4B illustrates a planar structure. The base station antenna, illustrated in FIGS. 4A and 4B, has a structure in which a first radiating element 3 in a low frequency band of 700 MHz and second radiating elements 2 in a high frequency band of 1.9 GHz are properly arranged on a reflection plate 1 that stands erect in the longitudinal direction, in which the four second radiating elements 2 are arranged on the upper left and right sides and the lower left and right sides of the first radiating element 3. In this case, a beam-width expanding apparatus 10, according to an embodiment of the present invention, is disposed above each second radiating element 2. The second radiating element 2 and the beam-width expanding apparatus 10 illustrated in FIGS. 4A and 4B may have the same structure as the radiating element 2 and the beam-width expanding apparatus 10 illustrated in FIGS. 1 to 3.

Referring to FIGS. 4A and 4B, it can be seen that the beam-width expanding apparatus 10 is disposed above the second radiating element 2 to expand the beam width of the second radiating element 2. In this case, the mounting height and the size of the beam-width expanding apparatus 10 are designed not to cause serious damage to the radiation characteristic of the first radiating element 3 where possible in consideration of the first radiating element 3 near the beam-width expanding apparatus.

In addition, as illustrated in FIGS. 4A and 4B, auxiliary side walls 4, made of the same material as the reflection plate 1, are additionally mounted on opposite sides of the second radiating element 2 in order to expand the beam width of the second radiating element 2. Such auxiliary side walls 4 may be additionally used for expanding the beam width of the second radiating element 2, in which case the beam width of the second radiating element 2 can be optimized by properly designing the height of the auxiliary side walls 4.

In order to expand the beam width of the second radiating element 2, it may be additionally considered to increase the height of the second radiating element 2. However, increasing the height of the second radiating element 2 to a proper value or more may degrade a Voltage Standing Wave Ratio (VSWR) characteristic and affect the radiation characteristic of the first radiating element 3 disposed near the second radiating element 2.

Furthermore, a method may be considered for expanding the beam width of the radiating element by decreasing the width of the reflection plate 1. However, when the width of the reflection plate 1 is decreased to a proper value or smaller, the Front-to-Back Ratio (FBR) of the antenna is degraded due to a deficiency in a ground contact area.

Accordingly, in order to expand the beam width of the second radiating elements 2, the auxiliary side walls 4, the height of the second radiating element 2, and the width of the reflection plate 1 are appropriately designed. This helps the beam width of the second radiating element 2 to be formed as wide as possible in a range satisfying the radiation characteristic required for the entire antenna. In addition, the beam-width expanding apparatus 10, according to the present invention, may be additionally provided, thereby doubling the beam-width expansion effect.

Moreover, the beam-width expanding apparatus, according to the present invention, may be additionally mounted in a comparatively simple manner without any change in the radiating element structure of an existing antenna, thereby expanding the beam width of radiating elements of the corresponding antenna.

The configuration and operation of the mobile communication base station antenna including the beam-width expanding apparatus according to the embodiment of the present invention may be made as described above, and although the specific embodiment of the present invention has been described above, various modifications can be made without departing from the scope of the present invention.

In the above-described embodiment, it has been illustrated that the beam-width expanding apparatus has a circular interconnected ring shape with a plurality of branch portions extending inward. However, the beam-width expanding apparatus may have a non-interconnected structure, or may have a rectangular shape or include branch portions extending outward rather than inward.

In the above-described embodiment, it has been illustrated that the support parts fix the beam-width expanding apparatus using the through holes formed in the beam-width expanding apparatus. However, the support parts may have various structures such as fixing the beam-width expanding apparatus in such a manner of holding a portion of the beam-width expanding apparatus using a clip structure.

In the above-described embodiment, it has been illustrated that the first radiating element and the second radiating elements are arranged in a particular structure as illustrated in FIGS. 4A and 4B. However, the first radiating element and the second radiating elements may have various arrangement structures. In addition, an antenna may be implemented only by second radiating elements in a particular structure, in which case the beam-width expanding apparatus of the present invention may be mounted thereto. Furthermore, although it has been illustrated in the above embodiment that the beam-width expanding apparatus is mounted only to the second radiating element, the beam-width expanding apparatus of the present invention may also be implemented in the first radiating element.

As described above, a mobile communication base station antenna including a beam-width expanding apparatus, according to the present invention, can expand the beam width of a radiating element with a comparatively simple structure and the minimum addition of equipment without affecting the radiation characteristic of the antenna where possible.

What is claimed is:

1. A mobile communication base station antenna having a beam-width expanding apparatus, comprising:
a reflection plate;
a radiating element mounted on the reflection plate; and
the beam-width expanding apparatus that is fixedly mounted to be spaced a preset distance apart from the radiating element in the radiating direction and constituted by a thin metal body.

2. The mobile communication base station antenna of claim 1, wherein the beam-width expanding apparatus is a thin metal body made of a conductive material.

3. The mobile communication base station antenna of claim 1, wherein the beam-width expanding apparatus has a circular ring shape and comprises a branch portion extending toward the center of the circular ring.

4. The mobile communication base station antenna of claim 1, wherein the beam-width expanding apparatus is fixedly mounted to the reflection plate through a separate support part.

5. The mobile communication base station antenna of claim 1, wherein auxiliary side walls made of the same material as the reflection plate are additionally mounted on opposite sides of the radiating element.

6. The mobile communication base station antenna of claim 1, wherein the beam-width expanding apparatus shares the same central axis with the radiating element.

7. The mobile communication base station antenna of claim 4, wherein the support part has one side coupled to the reflection plate and the other side coupled to the beam-width expanding apparatus and is formed of synthetic resin.
